(19) United States
(12) Patent Application Publication
(10) Pub. No.: US 2016/0244160 A1
(43) Pub. Date: Aug. 25, 2016

(54) CONVERTIBLE UNMANNED AERIAL VEHICLE

(71) Applicant: FourthWing Sensors, LLC, Mankato, MN (US)

(72) Inventors: Todd Michael Colten, St. Paul, MN (US); Christopher Scott Gibson, Waxhaw, NC (US); Ryan Nelson, Farmington, MN (US); Adem Rudin, Mountain View, CA (US)

(73) Assignee: FourthWing Sensors, LLC, Mankato, MN (US)

(21) Appl. No.: 14/454,200

(22) Filed: Aug. 7, 2014

Related U.S. Application Data
(60) Provisional application No. 61/864,257, filed on Aug. 9, 2013.

(51) Int. Cl. B64C 39/02; B60F 5/02; B64C 37/00

(52) U.S. Cl. CPC B64C 39/024; B64C 37/00; B60F 5/02; B64C 2201/125; B64C 2201/126; B64C 2201/146; B64C 2201/141; B64C 2201/108; B64C 2201/104; B64C 2211/00

(57) ABSTRACT

In one example, an unmanned aerial vehicle includes a fuselage and a lift assembly. The lift assembly is selected from a plurality of lift assemblies, each of the plurality of lift assemblies having a different flight modality. The fuselage includes a mounting portion configured to mount with any of the plurality of lift assemblies.

### CROSS-REFERENCE TO RELATED APPLICATIONS

This application claims priority to U.S. Provisional Application No. 61/864,257, filed on Aug. 9, 2013, and entitled “CONVERTIBLE AIRCRAFT,” the entire contents of which are hereby incorporated by reference.

### BACKGROUND

The present disclosure relates generally to unmanned aerial vehicles, and more particularly to unmanned aerial vehicles that can utilize any of a plurality of lift assemblies for flight.

An unmanned aerial vehicle (UAV) is a remotely piloted or self-piloted aircraft that can carry cameras, sensors, communications equipment, or other payloads. UAVs are often capable of controlled, sustained flight, and can be powered by, e.g., a battery, a fuel cell, a motor, an engine, or other power sources. UAVs may be remotely controlled (e.g., via joystick or other hand-actuated controller, remote computer, or other types of controllers), or may fly autonomously based on preprogrammed flight plans or complex dynamic automation systems.

UAVs have become increasingly utilized for various applications where the use of manned flight vehicles is not appropriate, not economical, or is not feasible. Example applications in which UAVs may typically be utilized can include surveillance, reconnaissance, target acquisition, data acquisition, communications relay, decoy, harassment, and supply flights. UAVs have also been utilized in a growing number of civilian applications, such as firefighting when a human observer would be at risk, police observation of civil disturbances or crime scenes, reconnaissance support in natural disasters, search and rescue, and scientific research, such as for collecting data from within storms (e.g., hurricanes).

UAVs are typically designed as either a fixed wing aircraft or a rotary wing aircraft, each having associated benefits and drawbacks. For example, fixed wing aircraft are typically capable of flying at higher airspeeds than rotary wing aircraft, but are generally incapable of hovering maneuvers as well as vertical take-offs and landings. In contrast, rotary wing aircraft are typically capable of hovering maneuvers and vertical take-offs and landings, but may be limited to lower airspeeds and shorter missions. Traditional hybrid designs typically sacrifice performance of both the fixed wing and rotary wing designs to achieve some of the advantages of both. Accordingly, where the full advantages of either the fixed wing or rotary wing design are desired, it has generally been necessary to utilize two different aircraft.

### SUMMARY

In one example, an unmanned aerial vehicle includes a fuselage and a lift assembly. The lift assembly is selected from a plurality of lift assemblies, each of the plurality of lift assemblies having a different flight modality. The fuselage includes a mounting portion configured to mount with any of the plurality of lift assemblies.

In another example, an unmanned aerial vehicle includes a fuselage, an electrical interface, and a controller. The fuselage includes a mounting portion configured to mount with any of a plurality of lift assemblies. Each of the plurality of lift assemblies has a different flight modality and one or more flight control surfaces corresponding to the respective flight modality. The electrical interface is configured to electrically connect the fuselage and any of the plurality of lift assemblies. The electrical interface is further configured to identify the flight modality of an electrically connected one of the plurality of lift assemblies. The controller is coupled to the electrical interface, and configured to determine the flight modality of the electrically connected one of the plurality of lift assemblies based on the electrical interface. The controller is further configured to provide control signals, based on the determined flight modality, to the flight control surfaces of the electrically connected one of the plurality of lift assemblies.

In another example, an unmanned aerial vehicle includes an elongate body portion and a lift assembly connected to the elongate body portion via an attachment mechanism. The lift assembly is selected from a plurality of lift assemblies, each having a different flight modality. The attachment mechanism is configured to connect the elongate body portion to any of the plurality of lift assemblies.

In another example, an unmanned aerial vehicle system includes a fixed wing lift assembly, a rotor lift assembly, and a fuselage. The fuselage has a mounting portion configured to mount with each of the fixed wing lift assembly and the rotor lift assembly via a common attachment mechanism.

### BRIEF DESCRIPTION OF THE DRAWINGS

FIG. 1 is schematic view of an example unmanned aerial vehicle system showing conversion between fixed wing and quad-rotor lift assemblies.

FIG. 2 is a perspective view of an unmanned aerial vehicle having a fuselage mounted with a quad-rotor lift assembly.

FIG. 3 is a perspective view of an unmanned aerial vehicle having a fuselage mounted with a fixed wing lift assembly.

FIG. 4 is a perspective view of a female component of an attachment mechanism that can be used to connect a lift assembly to a mounting portion of a fuselage.

FIG. 5 is a perspective view of an insert for the female component of the attachment mechanism of FIG. 4.

FIG. 6 is a perspective view of a sliding bolt attachment mechanism that can be used to connect a lift assembly to a mounting portion of a fuselage.

FIG. 7 is an exploded view of the sliding bolt attachment mechanism of FIG. 6.

FIG. 8 is a perspective view of the sliding bolt attachment mechanism of FIG. 7.

FIG. 9 is a perspective view of a fuselage including an electrical component configured to interface with a corresponding electrical component of any of a plurality of lift assemblies.

FIG. 10 is a schematic side view of an example electrical interface of FIG. 9.

FIG. 11 is a schematic side view of the example electrical interface of FIG. 10 showing the electrical components connected.

FIG. 12 is a schematic side view of another example electrical interface that can connect with a lift assembly.

FIG. 13 is a perspective view of a mounting cavity that can receive a power source for the unmanned aerial vehicle.

FIG. 14 is a front view of an alternate embodiment of an unmanned aerial vehicle having a fuselage mounted with a fixed wing lift assembly.

FIG. 15 is a front view of an alternate embodiment of an unmanned aerial vehicle having a fuselage mounted with a single-rotor lift assembly.

While the above-identified drawings set forth multiple embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals indicate like structures throughout the drawings.

### DETAILED DESCRIPTION

According to techniques of this disclosure, an unmanned aerial vehicle (UAV) can include a fuselage having a mounting portion configured to connect with any of a plurality of lift assemblies. Each of the lift assemblies can have a different flight modality. For instance, a first lift assembly can have a fixed wing flight modality, a second lift assembly can have a single-rotor flight modality, and a third lift assembly can have a quad-rotor flight modality. In some examples, the UAV can include a controller connected to an electrical interface configured to couple to each of the lift assemblies. The electrical interface can be configured to identify a flight modality of the connected lift assembly, such as via an active pin arrangement (e.g., pattern) of the electrical interface. The controller can identify the flight modality of the connected lift assembly and can provide corresponding flight control signals to control surfaces of the lift assembly to provide controlled flight of the UAV. As such, a UAV implementing techniques described herein can convert between different flight modalities (e.g., between a fixed wing flight modality and a rotary wing flight modality) to exploit advantages of a particular flight modality without requiring the purchase, storage, maintenance of or training on separate UAVs implementing the separate flight modalities. Moreover, a common controller, power source, and payload mount (e.g., each connected to or included in a common fuselage) can decrease a monetary expense of the UAV system as a whole, as well as training time and costs associated with use of the UAV system. Common attachment mechanisms can enable quick and efficient interchanges between lift systems, while automatic identification of a flight modality of a connected lift system can enhance usability of the UAV.

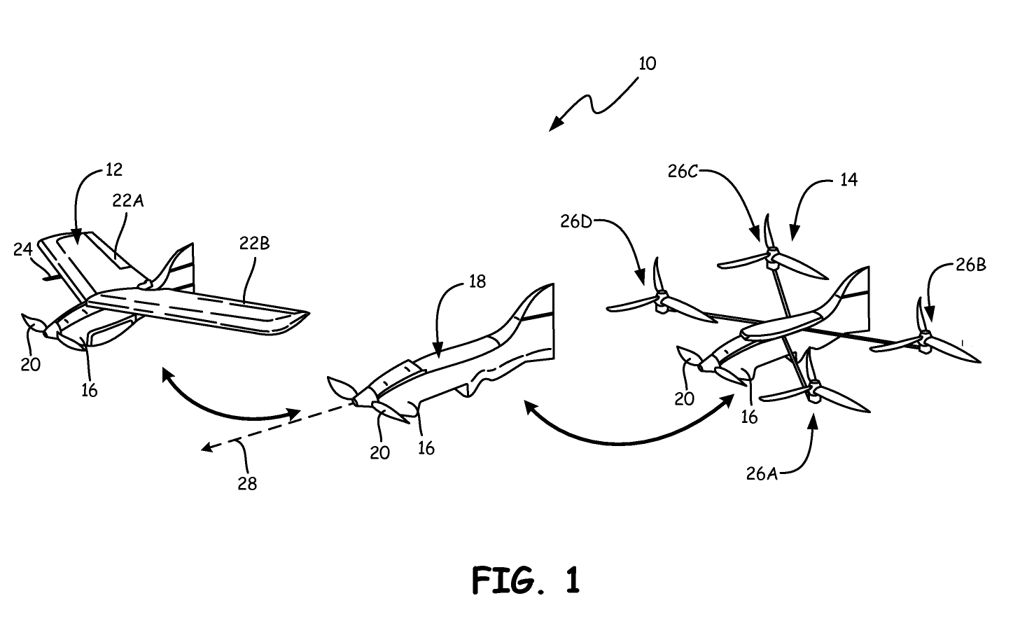

FIG. 1 is schematic view of UAV system 10 showing a conversion between fixed wing lift assembly 12 and quad-rotor lift assembly 14. As illustrated, UAV system 10 can include fuselage 16, fixed wing lift assembly 12, and quad-rotor lift assembly 14. Fuselage 16 includes mounting portion 18 and propeller 20. While illustrated as including two lift assemblies 12 and 14, in other examples UAV system 10 can include more than two lift assemblies, such as three or more lift assemblies. For instance, UAV system 10 can further include a single-rotor lift assembly, a dual-rotor lift assembly, or other types of lift assemblies. In addition, while illustrated as including both fixed wing lift assembly 12 having a fixed wing flight modality and quad-rotor lift assembly 14 having a quad-rotor flight modality, in some examples, UAV system 10 may not include one or more of fixed wing lift assembly 12 and quad-rotor lift assembly 14.

Fixed wing lift assembly 12 includes elevons 22A and 22B (collectively referred to herein as “elevons 22”) and pitot probe 24. Elevons 22 can be deflected up and down via actuators (not illustrated) to provide pitch control (e.g., both deflected up or both deflected down) and roll control (e.g., one deflected up and the other deflected down) during flight. As such, elevons 22 can be considered flight control surfaces that can be utilized for controlled flight, such as via actuation by a controller attached to fuselage 16 (e.g., a controller implementing autopilot functionality), as is further described below. Pitot probe 24 can include one or more pressure sensors that sense a velocity of air impacting pitot probe 24 for use in determining, e.g., airspeed. In this way, pitot probe 24 can be considered a sensor configured to sense data corresponding to flight conditions of the UAV. In some examples, UAV system 10 can include other sensors configured to sense flight condition data, such as one or more of a magnetometer, an accelerometer, a gyroscope, a global positioning system (GPS) receiver, or other sensors.

Quad-rotor lift assembly 14 includes rotor assemblies 26A, 26B, 26C, and 26D (collectively referred to herein as “rotor assemblies 26”). A rotational speed of each of rotor assemblies 26 can be controlled independently (e.g., via a controller) to provide thrust, lift, pitch, and roll control of the UAV. As such, each of rotor assemblies 26 can be considered flight control surfaces that can be utilized for controlled flight of the UAV.

Fuselage 16 can include propeller 20 that can be actuated (e.g., via a motor) to provide thrust for the UAV along axis 28. As illustrated, fuselage 16 can include an elongated body portion having a major axis extending along axis 28. In this way, fuselage 16 can be formed for aerodynamic flight along axis 28 which defines the axis of thrust provided by propeller 20. In other examples, fuselage 16 may not include an elongated body portion. For instance, fuselage 16 can be square, circular, or other non-elongated shape. Fuselage 16 further includes mounting portion 18. Mounting portion 18 can be configured to mount with each of fixed wing lift assembly 12 and quad-rotor lift assembly 14, e.g., via one or more connection mechanisms, as is further described below. In the example of FIG. 1, mounting portion 18 is disposed at a top side of fuselage 16 (i.e., a top side with respect to an orientation of fuselage 16 during normal flight conditions). In other examples, mounting portion 18 can be disposed at other locations of fuselage 16, such as at a bottom side or another location of fuselage 16. In general, mounting portion 18 can be disposed at any portion(s) of fuselage 16 that enables mounting of fuselage 16 with any of a plurality of lift assemblies.

As illustrated in FIG. 1, UAV system 10 can be converted between a fixed wing flight modality and a quad-rotor flight modality. That is, each of fixed wing lift assembly 12 and quad-rotor lift assembly 14 can be removably connected to mounting portion 18 to enable conversion between the fixed wing and quad-rotor flight modalities. In general, mounting portion 18 can be configured to mount with any of a plurality of lift assemblies, such as two, three, four, or more lift assemblies, each of which configured to be removably connected to mounting portion 18 to enable conversion between the flight modalities associated with each of the plurality of lift assemblies. In this way, UAV system 10 can be configured such that flight is accomplished via any of the plurality of flight modalities, thereby enabling UAV system 10 to exploit the full advantages of any of the plurality of flight modalities.

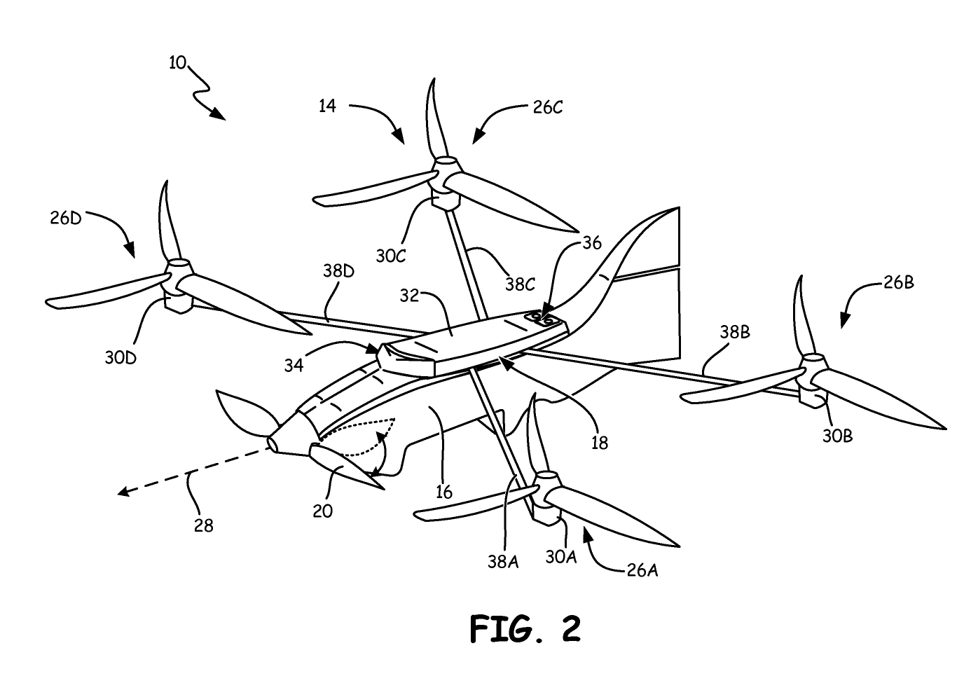

FIG. 2 is a perspective view of UAV system 10 having fuselage 16 mounted with quad-rotor lift assembly 14. As illustrated in FIG. 2, quad-rotor lift assembly 14 includes rotor assemblies 26. Each of rotor assemblies 26 includes a corresponding motor that provides rotational actuation of the blades of the respective one of rotor assemblies 26. That is, rotor assembly 26A includes motor 30A, rotor assembly 26B includes motor 30B, rotor assembly 26C includes motor 30C, and rotor assembly 26D includes motor 30D (motors 30A, 30B, 30C, and 30D are collectively referred to herein as “motors 30”). Quad-rotor lift assembly 14 includes mounting plate 32 which connects with mounting portion 18 of fuselage 16 via forward coupling mechanism 34 and aft coupling mechanism 36. As illustrated, rotor assembly 14 further includes extension arms 38A, 38B, 38C, and 38D (collectively referred to herein as “extension arms 38”) that extend from mounting plate 32 to each of rotor assemblies 26, respectively. That is, extension arm 38A connects to mounting plate 32 and extends from mounting plate 32 to rotor assembly 26A. Extension arm 38B connects to mounting plate 32 and extends from mounting plate 32 to rotor assembly 26B. Extension arm 38C connects to mounting plate 32 and extends from mounting plate 32 to rotor assembly 26C. Extension arm 38D connects to mounting plate 32 and extends from mounting plate 32 to rotor assembly 26D.

Extension arms 38 can be rigid extensions formed of lightweight material having a high tensile strength, such as aluminum, titanium, composite material (e.g., carbon fiber), or other material suitable to fixedly attach rotor assemblies 26 at a distance from fuselage 16. In addition, extension arms 38 can include a hollow interior that provides a conduit for electrical cables from fuselage 16 to each of rotor assemblies 26, such as electrical cables to provide power or other electrical signals to each of rotor assemblies 26. For instance, each of motors 30 can be electrically connected, via electrical cables extending through extension arms 38, to a controller within fuselage 16 that provides flight control signals to each of motors 30 (e.g., electrical signals to control a rotational speed of each of motors 30), as is further described below. In other examples, electrical cables can extend along an outer side of extension arms 38, e.g., fixed to extension arms 38 at one or more locations to prevent excessive movement of the cables. In such examples, extension arms 38 may not be hollow.

As illustrated in FIG. 2, mounting plate 32 connects to mounting portion 18 of fuselage 16 via forward coupling mechanism 34 and aft coupling mechanism 36. Forward coupling mechanism 34 can include, as in the example of FIG. 2, a female mating component, such as an arcuate recess configured to receive a corresponding male mating component of mounting plate 32. Aft coupling mechanism 36, in the example of FIG. 2, includes a plurality of sliding bolt connectors configured to connect to corresponding recesses in an aft portion of fuselage 16, as is further described below. Forward coupling mechanism 34 and aft coupling mechanism 36 secure mounting plate 32 to fuselage 16 at mounting portion 18, thereby securing lift assembly 14 to fuselage 16 for controlled flight of the UAV. Forward coupling mechanism 34 and aft coupling mechanism 36 are only two examples of attachment mechanisms that can be used to secure lift assembly 14 to fuselage 16, and other example attachment mechanisms are contemplated. For instance, one or more of forward coupling mechanism 34 and aft coupling mechanism 36 can be bolted connections, cam connections, interference fit connections, or other connections configured to secure mounting plate 32 to fuselage 16. In some examples, mounting plate 32 can be secured to fuselage 16 via greater or fewer coupling mechanisms than the two coupling mechanisms illustrated in the example of FIG. 2 (e.g., one, three, four, or more coupling mechanisms). In general, mounting portion 18 can include any number of coupling mechanisms sufficient to secure any of a plurality of lift assemblies to fuselage 16.

As further illustrated in FIG. 2, fuselage 16 can be connected to propeller 20 that is configured to provide thrust along axis 28 during flight. In some examples, propeller 20 can be actuated (i.e., rotated) to provide thrust along axis 28 during flight via the quad-rotor flight modality provided by quad-rotor lift assembly 14. For instance, each of rotor assemblies 26 can be controlled (e.g., via a controller device) to provide lift, thrust, pitch, and roll control of the UAV during flight. In some examples, propeller 20 can be actuated (i.e., in addition to each of rotor assemblies 26) to provide additional thrust along axis 28 during flight. In other examples, propeller 20 may not be actuated during flight via a rotary wing flight modality (e.g., a single rotor flight modality, a dual rotor flight modality, a tri-rotor flight modality, a quad-rotor flight modality, or other rotary wing flight modality). Propeller 20 can be formed of plastic, fiberglass, composite material (e.g., carbon fiber), metal (e.g., aluminum, titanium, etc.), or other material having a stiffness sufficient to enable propeller 20 to provide thrust via rotation. In some examples, such as the example of FIG. 2, propeller 20 can be hinged to enable each of the propeller blades to be folded against fuselage 16 (e.g., a retracted position), thereby removing aerodynamic drag resulting from the propeller blades when they are not being actuated. In certain examples, such as when propeller 20 is formed of a resilient material such as plastic, propeller 20 may not be hinged, but may be folded against fuselage 16 into the retracted position without the use of a hinge. In some examples, fuselage 16 can include a recess configured to accept propeller 20 when propeller 20 is in the retracted position, thereby further reducing aerodynamic drag caused by propeller 20 when it is not being actuated. In certain examples, fuselage 16 can include one or more retention mechanisms, such as a strap, snap, or other retention mechanism to secure the blades of propeller 20 in the retracted position.

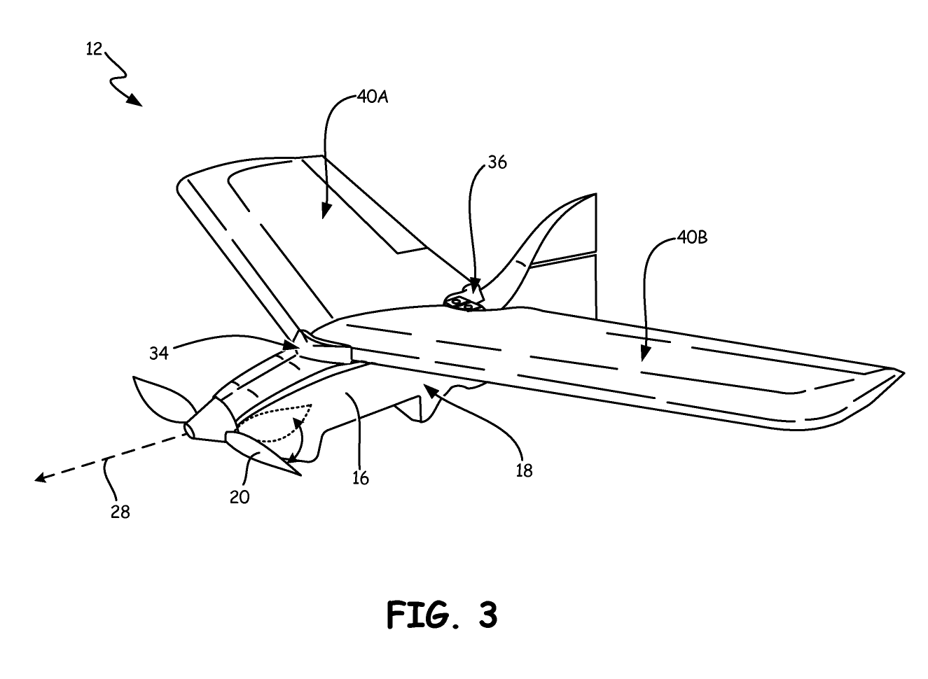

FIG. 3 is a perspective view of UAV system 10 having fuselage 16 mounted with fixed wing lift assembly 12. As illustrated in FIG. 3, fixed wing lift assembly 12 can include starboard wing portion 40A and port wing portion 40B (collectively referred to herein as “wing portions 40”). Wing portions 40 can be separable but complementary wing portions that, when connected, form a unified flight surface (i.e., airfoil) to provide lift and enable controlled flight of the UAV. In some examples, fixed wing lift assembly 12 can include more than the two wing portions 40 illustrated in the example of FIG. 3, such as three or more complementary wing portions that assemble to provide a unified flight surface. In other examples, fixed wing lift assembly 12 can include a single wing portion that provides a unified flight surface. For instance, wing portions 40A and 40B may not be separable, but may form a single, unified flight surface configured to attach to mounting portion 18 of fuselage 16.

As illustrated in FIG. 3, fixed wing lift assembly 12 connects to mounting portion 18 via forward coupling mechanism 34 and aft coupling mechanism 36. As illustrated by like numerals, forward coupling mechanism 34 and aft coupling mechanism 36 can be common to the coupling mechanisms utilized by UAV system 10 to connect quad-rotor lift assembly 14 to mounting portion 18. As such, mounting portion 18 can include one or more attachment mechanisms that enable connection of any of a plurality of lift assemblies via the attachment mechanisms. In this way, mounting portion 18 can include one or more attachment mechanisms that are configured to be common between each of the plurality of lift assemblies, thereby facilitating ease of attachment, detachment, and interchangeability of each of the plurality of lift assemblies.

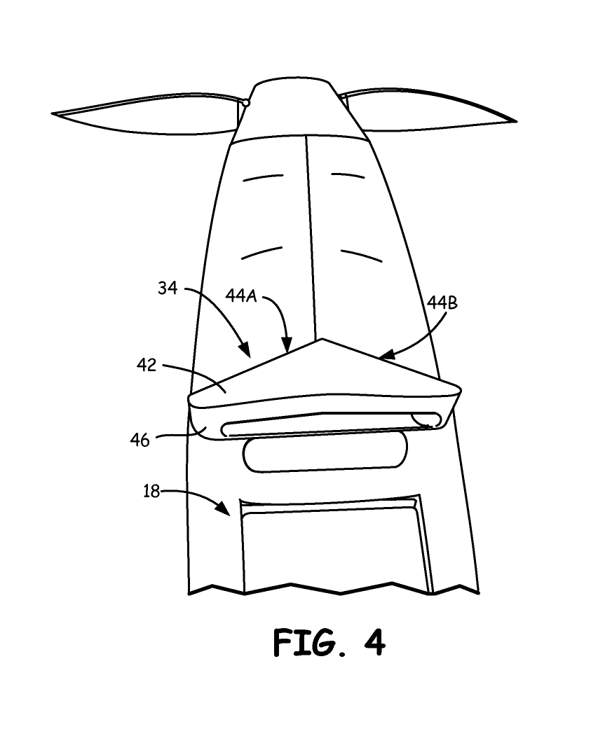

FIG. 4 is a perspective view of female component 42 of forward coupling mechanism 34 that can be configured to connect with a corresponding male component to connect a lift assembly to mounting portion 18 of fuselage 16. As illustrated in FIG. 4, female component 42 connects to (or extends from) mounting portion 18. Female component 42 can be formed of a single piece of material, such as a lightweight material having high tensile strength (e.g., aluminum, titanium, composite material such as carbon fiber, or other material). In other examples, female component 42 can be formed of multiple (e.g., two, three, or more) pieces configured to be assembled to form a mounting configuration of female component 42 that is configured to receive a corresponding male component for mounting any one of a plurality of lift assemblies to mounting portion 18.

Female component 42 can be formed to include first sidewall portion 44A and second sidewall portion 44B (collectively referred to herein as “sidewall portions 44”). As illustrated, sidewall portions 44 can be angled to intersect at an obtuse angle. In other examples, sidewall portions 44 can intersect at a different angle, such as an acute angle. In yet other examples, sidewall portions 44 can intersect to form a rounded, flat, or other blunt-nosed intersection.

As further illustrated in FIG. 4, forward coupling mechanism 34 can include mating insert 46. Mating insert 46 can be formed to include an outer surface complementary to an inner surface of female component 42, thereby enabling insertion of mating insert 46 into female mating component 42. Mating inert 46, as illustrated, can include angled inner surfaces that extend within female mating component 42 to form an arcuate recess, as is further described below. In some examples, mating insert 46 can be removable from female component 42. In other examples, mating insert 46 can be integrally formed within female component 42, such that mating insert 46 is not removable from female component 42. In yet other examples, female component 42 may not include mating insert 46. Mating insert 46 can be formed of plastic, metal (e.g., aluminum, titanium, etc.), composite material, or other material having hardness sufficient to allow removable attachment of a complementary male component with mating insert 46 without deformation of mating insert 46.

While illustrated and described as including female component 42 attached to or extending from fuselage 16, in other examples, female mating component 42 can be attached to a lift assembly. In such examples, mounting portion 18 can include a male mating component corresponding to female mating component 42. In general, female component 42 and the corresponding male mating component can be disposed at either of fuselage 16 or a lift assembly, such that each of fuselage 16 and the lift assembly include one of female mating component 42 and the corresponding male mating component.

FIG. 5 is a perspective view of mating insert 46 of FIG. 4. As illustrated in FIG. 5, mating insert 46 can be formed to include outer surface 48 and inner surface 50. Outer surface 48 can be formed to be inserted within female component 42 (illustrated in FIG. 4), such that outer surface 48 contacts an inner surface of female component 42 along an entirety of outer surface 48. In other examples, outer surface 48 can be formed to be inserted within female component 42, such that outer surface 48 contacts an inner surface of female component 42 along a portion of outer surface 48 sufficient to prevent movement of mating insert 46 within female component 42, but not along the entirety of outer surface 48. In general, outer surface 48 can be formed to have a shape that is complementary to a shape of an inner surface of female component 42 to enable insertion of mating insert 46 within female component 42 such that mating insert 46 is secured within female component 42 when a lift assembly is mounted to mounting portion 18.

Inner surface 50 of mating insert 46 can be formed to receive a corresponding male component of forward coupling mechanism 34. For instance, as illustrated in FIG. 5, inner surface 50 can include angled inner walls that intersect at an obtuse angle to receive a complementary, e.g., pointed, male mating component. In some examples, inner surface 50 can be formed to complement a male mating component of a specific lift assembly, thereby enabling multiple mating inserts 46 to be utilized for mating each of a plurality of lift assemblies with forward coupling mechanism 34. For instance, outer surface 48 of a first mating insert 46 can be formed to complement an inner surface of female component 42, and inner surface 50 of the first mating insert 46 can be formed to complement a male mating component of a fixed wing lift assembly (e.g., fixed wing lift assembly 12). Similarly, outer surface 48 of a second, different mating insert 46 can be formed to complement an inner surface of female component 42, and inner surface 50 of the second mating insert 46 can be formed to complement a male mating component of a rotary wing lift assembly, such as quad-rotor lift assembly 14. In this way, female component 42 can be a common portion of forward coupling mechanism 34, and one or more mating inserts 46 can be configured to enable mating of female component 42 with any of a plurality of different male components.

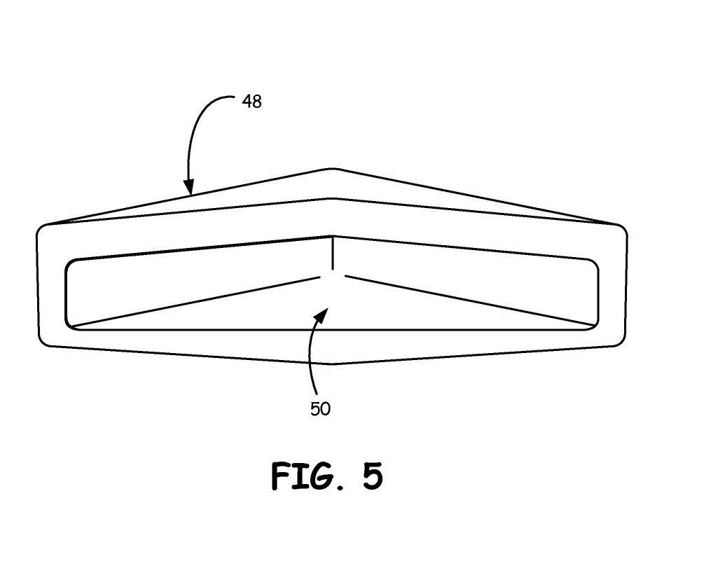

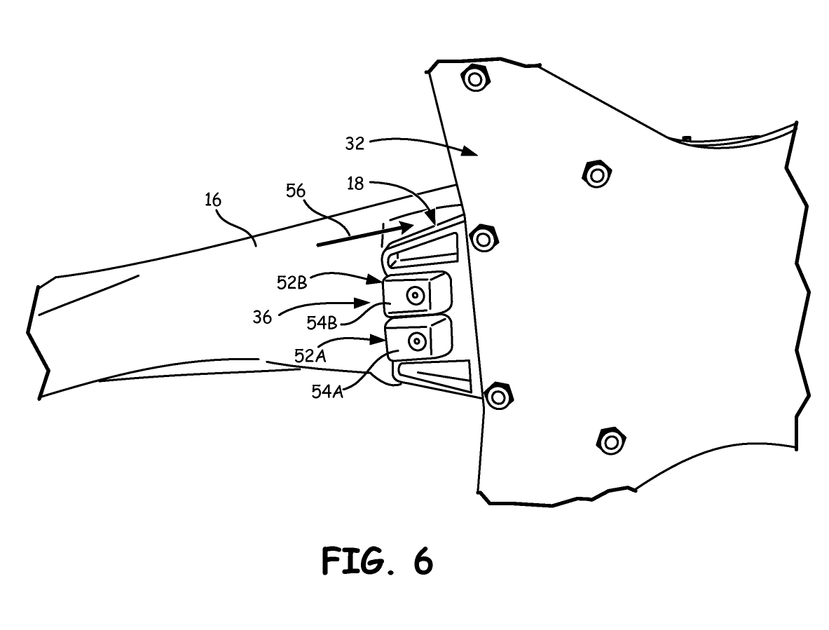

FIG. 6 is a perspective view of aft coupling mechanism 36 of FIG. 4. Aft coupling mechanism 36 can include sliding bolt attachment mechanisms 52A and 52B (collectively referred to herein as “sliding bolt attachment mechanisms 52”). As illustrated in FIG. 6, sliding bolt attachment mechanism 52A can include knob 54A. Sliding bolt attachment mechanism 52B can include knob 54B (knobs 54A and 54B are collectively referred to herein as “knobs 54”). Sliding bolt attachment mechanisms 52 can be configured to releasably connect a lift assembly to an aft portion of mounting portion 18. For instance, in the example of FIG. 6, knobs 54 are configured to be movable in the direction indicated by arrow 56 to a disengagement position to release an engagement bolt that is configured to engage a corresponding pocket within fuselage 16 that secures mounting plate 32 to mounting portion 18, as is further described below. Knobs 54 can be biased (e.g., spring-biased) to an engagement position, such that knobs 54 return to the engagement position when sufficient force is not applied to overcome the bias.

While illustrated in the example of FIG. 6 as securing mounting plate 32 of quad-rotor lift assembly 14 to mounting portion 18, aft coupling mechanism (including, e.g., sliding bolt attachment mechanisms 52) can secure any of a plurality of lift assemblies to mounting portion 18, such as fixed wing lift assembly 12. For instance, sliding bolt attachment mechanism 52A can secure wing portion 40A (illustrated in FIG. 3) to mounting portion 18, and sliding bolt attachment mechanism 52B can secure wing portion 40B (illustrated in FIG. 3) to mounting portion 18. In some examples, aft coupling mechanism 36 can include a single sliding bolt attachment mechanism (e.g., a single one of sliding bolt attachment mechanisms 52) that is configured to secure a lift assembly to mounting portion 18. In other examples, sliding bolt attachment mechanisms 52 can take the form of other connection mechanisms, such as cam connection(s), interference fit connection(s), or one or more other fastening mechanisms configured to secure mounting plate 32 to mounting portion 18. In general, aft coupling mechanism 36 can include any one or more connection mechanisms that can removably connect any of a plurality of lift assemblies to mounting portion 18.

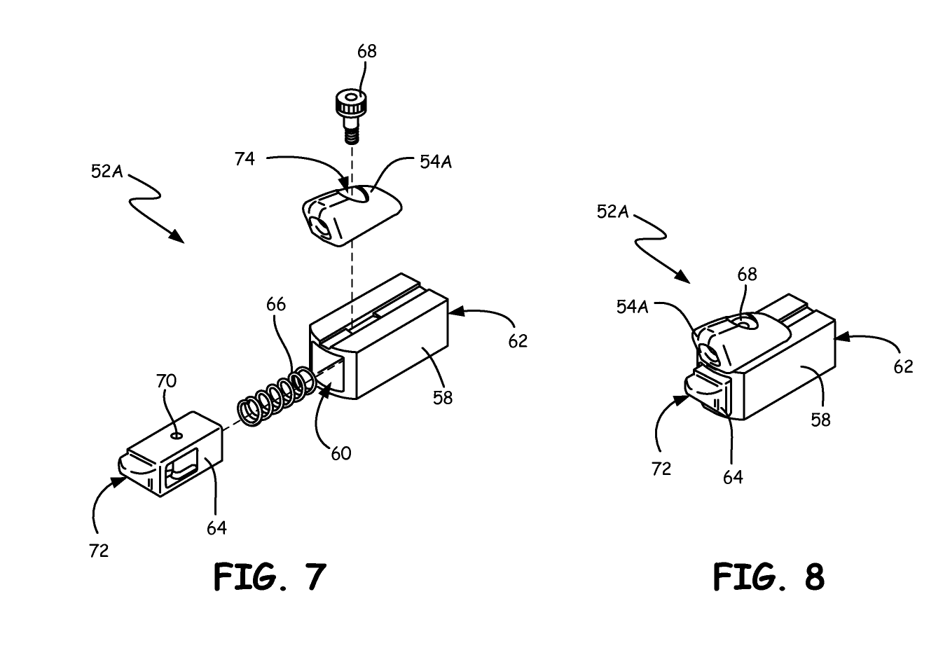

FIG. 7 is an exploded view of sliding bolt attachment mechanism 52A of FIG. 6. While illustrated and described with respect to sliding bolt attachment mechanism 52A, the illustration and associated description of FIG. 7 can also be applicable to sliding bolt attachment mechanism 52B.

As illustrated in FIG. 7, sliding bolt attachment mechanism 52A includes knob 54A, housing 58 extending from open end 60 to closed end 62, bolt 64, spring 66, and fastener 68. Bolt 64 includes bore 70 and engagement portion 72. Bolt 64 is configured to be inserted within housing 58 through open end 60 and to slide within housing 58 between an engagement position and a disengagement position, as is further described below. Spring 62 is configured to be disposed between bolt 64 and closed end 62 of housing 58. When assembled, spring 62 urges bolt 64 in a direction from closed end 62 to open end 60, thereby biasing bolt 64 into an engagement position. As illustrated, knob 54A is configured to be positioned atop housing 58. Fastener 68, which can be a bolt, screw, rivet, or other fastening device, is configured to be inserted through bore 74 of knob 54A to engage bore 70 (e.g., a threaded bore) and thereby secure knob 54A to bolt 64. Knob 54A is configured to be movable along an axis of housing 58 that extends between open side 60 and closed side 62.

Bolt 64 further includes engagement portion 72 that can be configured to engage a corresponding recess in fuselage 16 when bolt 64 is in the engagement position. As illustrated in FIG. 7, engagement portion 72 can be a beveled tab. In other examples, engagement portion 72 can be a post, bolt, or other protrusion that extends from bolt 64 to engage a corresponding recess within fuselage 16 when bolt 64 is in the engagement position.

In operation, when force is applied to knob 54A in a direction toward closed side 62 with magnitude sufficient to overcome a spring constant of spring 66, knob 54A and bolt 64 (via the connection of fastener 68 to bore 70) move in a direction toward closed side 62. In this way, bolt 64 can be moved to a disengagement position in which engagement portion 72 disengages from the corresponding recess in fuselage 16 to disengage sliding bolt attachment mechanism 52A from fuselage 16. When force is no longer applied to knob 52A with sufficient magnitude to overcome the spring constant of spring 66, spring 66 urges bolt 64 in a direction toward open end 60 to the engagement position in which engagement portion 72 can engage the corresponding recess in fuselage 16. In this way, sliding bolt attachment mechanism 52A can enable tool-less connection and disconnection of a lift assembly with mounting portion 18 of fuselage 16. In addition, beveled edges of engagement portion 72 can enable engagement portion 72 to disengage from the corresponding recess within fuselage 16 when sufficient force is applied in a direction orthogonal to the axis extending between open end 60 and closed end 62 of housing 58. In this way, sliding bolt attachment mechanism 52A can enable a connected lift assembly to self-disassemble upon a hard impact with, e.g., the ground, thereby dissipating the impact force and helping to prevent and/or reduce damage to components of the UAV (e.g., damage to the connected lift assembly). Moreover, knob 54A, as illustrated, can be both ergonomic for typical manipulation by human fingers and aerodynamic to reduce drag during flight.

FIG. 8 is a perspective view of sliding bolt attachment mechanism 52A as described above with respect to FIG. 7. FIG. 8 illustrates sliding bolt attachment mechanism 52A in an assembled state with bolt 64 in the engagement position. As illustrated in FIG. 8, bolt 64 is inserted within housing 58. Fastener 68 is inserted through bore 74 of knob 54A to engage bore 70 and connect bolt 64 to knob 54A. In the illustrated example, spring 66 urges bolt 64 into the engagement position such that engagement portion 72 of bolt 64 extends from housing 58 to engage a corresponding recess within fuselage 16 (not illustrated). In operation, movement of knob 54A toward closed end 62 of housing 58 (e.g., via finger actuation) slides bolt 64 within housing 58 toward closed end 62 until engagement portion 72 is in the disengagement position (e.g., until engagement portion 72 no longer extends from housing 58). Releasing pressure from knob 54A allows spring 66 to urge bolt 64 away from closed end 62 until engagement portion 72 is in the engagement position (e.g., until engagement portion 72 extends from housing 58 to engage a corresponding recess within fuselage 16).

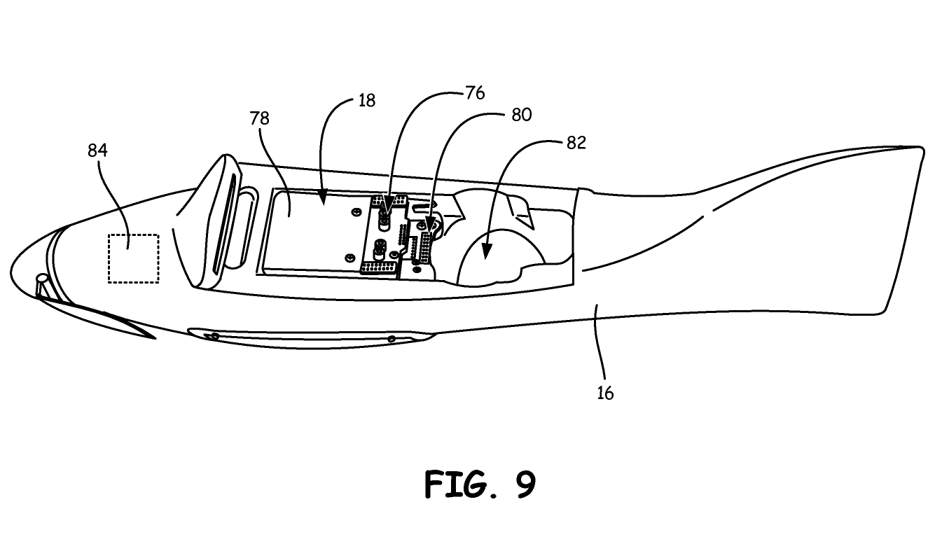

FIG. 9 is a perspective view of fuselage 16 including mounting portion 18 having electrical component 76 that is configured to interface with a corresponding component of any of a plurality of lift assemblies. As illustrated in FIG. 9, fuselage 16 can further include controller 78, payload electrical interface 80, payload attachment interface 82, and motor 84. Electrical component 76 can be configured to interface with a corresponding electrical component of any of a plurality of lift assemblies, such as via a plurality of electrical pins and pads disposed at the electrical components, as is further described below. Electrical component 76 and the corresponding electrical component of a connected lift assembly can form an electrical interface that can identify the flight modality of the connected lift assembly, such as via an active pin arrangement of the electrical interface.

While the example of FIG. 9 is described with respect to an electrical interface (i.e., including electrical component 76) that can identify a flight modality of a connected lift assembly via an active pin arrangement, aspects of this disclosure are not so limited. For instance, controller 78 can identify a flight modality of a connected lift assembly via a wired or wireless connection, or both. As an example, each of controller 78 and the plurality of lift assemblies can include communications circuitry and/or a wireless transmitter (or transceiver), such as a Bluetooth transceiver, a cellular network transceiver, a WiFi transceiver, an optical transceiver (e.g., an infrared transceiver), a radio frequency transceiver, or other type of transmitter and/or transceiver. In certain examples, controller 78 can interrogate the communications circuitry of the lift assembly via the wireless communications connection to determine the flight modality of a connected lift assembly. In other examples, the communications circuitry of the lift assembly can broadcast an indication of the flight modality of the lift assembly, which can be received and identified by controller 78. In one example, controller 78 can include and/or be connected to a radio frequency identification (RFID) reader, and a lift assembly can include and/or be connected to an RFID tag configured to transmit an indication of the flight modality of the lift assembly. In such an example, the RFID reader connected to controller 78 can interrogate the RFID tag to receive the indication of the flight modality of the lift assembly.

As in the example of FIG. 9, controller 78 can be electrically connected to electrical component 76 and payload electrical interface 80. In some examples, controller 78 can be electrically connected to one or more components of a connected lift assembly via the electrical connection of electrical component 76 and the corresponding electrical component of the connected lift assembly. For instance, controller 78 can be electrically connected to motors 30 of quad-rotor lift assembly 14 (illustrated in FIG. 2) via the electrical interface. As another example, controller 78 can be electrically connected to one or more actuators of fixed wing lift assembly 12 that actuate elevons 22 (illustrated in FIG. 1).

Controller 78 can include processing circuitry configured to implement functionality and/or process instructions for execution within controller 78. For example, controller 78 can include and/or be coupled to one or more computer-readable storage devices, such as random access memories (RAM), dynamic random access memories (DRAM), static random access memories (SRAM), flash memories, forms of electrically programmable memories (EPROM) or electrically erasable and programmable memories (EEPROM), or other forms of volatile and/or non-volatile memories. The one or more storage devices can include computer-readable instructions which, when executed by controller 78, cause controller 78 to operate in accordance with the techniques described herein. Example processing circuitry included in controller 78 can include, but is not limited to, one or more of a microprocessor, a digital signal processor (DSP), an application specific integrated circuit (ASIC), a field-programmable gate array (FPGA), or other equivalent discrete or integrated logic circuitry.

Controller 78 can be configured to identify the flight modality of a connected one of a plurality of lift assemblies via the electrical interface with electrical component 76. For instance, as is further described below, controller 78 can determine a flight modality of a connected lift assembly based on an active pin arrangement of the electrical interface. Controller 78 can be configured to provide outputs to one or more flight controls of the connected lift assembly based on the determined flight modality. For example, controller 78 can determine that a connected lift assembly has a fixed wing flight modality (e.g., fixed wing lift assembly 12). In response, controller 78 can output flight control signals (e.g., via the connection through the electrical interface with electrical component 76 and the corresponding electrical component of the connected lift assembly) to cause elevons (e.g., elevons 22) of the fixed wing lift assembly to control pitch and roll of the UAV. As another example, controller 78 can determine that a connected lift assembly has a quad-rotor flight modality (e.g., quad-rotor lift assembly 14). In response, controller 78 can output flight control signals to cause motors (e.g., motors 30) of the quad-rotor lift assembly to actuate the rotors to control thrust, lift, pitch, and roll of the UAV. In general, controller 78 can be configured to output flight control signals to control flight of the UAV via the connected lift assembly based on the determined flight modality of the connected lift assembly.

In some examples, controller 78 can implement autopilot functionality to enable autonomous control of the UAV based on feedback from one or more sensors configured to sense data corresponding to flight conditions of the unmanned aerial vehicle (e.g., pitot probe 24, accelerometer(s), gyroscope(s), magnetometer(s), or other sensors). In certain examples, controller 78 can select and/or modify one or more parameters of the control law(s) within the autopilot based on the determined flight modality, such as one or more gains, lag constants, rate limiters, or other parameters of the control law(s). In some examples, controller 78 can select, from a set of control laws, one or more active control laws based on the determined flight modality. For instance, controller 78 can select one or more first control laws configured to provide, e.g., pitch control for the UAV via elevons as active control laws based on a determination that a flight modality of a connected flight assembly is a fixed wing flight modality. As another example, controller 78 can select one or more second control laws configured to provide, e.g., pitch control for the UAV via a quad-rotor assembly as active control laws based on a determination that a flight modality of a connected flight assembly is a quad-rotor flight modality. As such, controller 78 can be configured to implement an autopilot that autonomously controls flight of the UAV via any of a plurality of flight modalities corresponding to the flight modalities of a plurality of lift assemblies.

While the example of FIG. 9 illustrates controller 78 as included in fuselage 16, in other examples, controller 78 can be included within the connected lift assembly. For instance, each lift assembly from the plurality of lift assemblies can include a controller (e.g., controller 78) configured to connect to a power source (e.g., a power source included in fuselage 16, or a power source included in the lift assembly) and to provide flight control signals to the flight control surfaces of the lift assembly for controlled flight of the UAV. In some examples, each of fuselage 16 and a lift assembly can include a controller, with functionality attributed to controller 78 distributed among the controllers.

As further illustrated in FIG. 9, controller 78 can be electrically connected to payload electrical interface 80. Payload electrical interface 80 can be configured to connect with a payload, such as camera(s), sensor(s) (e.g., pressure sensors, temperature sensors, image sensors, moisture sensors, altimeters, and the like), communications equipment, or other payloads. Such payloads can be configured to be interchangeably connected to fuselage 16 via payload attachment interface 82, which can be a common attachment interface configured to connect with any of a plurality of payloads. In certain examples, payload electrical interface 80 can be configured to identify a type of a connected payload (e.g., a sensor type of the connected payload). For instance, payload electrical interface 80 can be substantially similar to electrical component 76, such that controller 78 can identify a type of a connected one of a plurality of payloads via electrical interface 80 (e.g., an active pin arrangement of electrical interface 80). In some examples, controller 78 can identify a type of a connected payload via wireless communications, such as via Bluetooth, WiFi, RFID, or other wireless communications.

Motor 84, in some examples, can be electrically connected to controller 78, which can provide control signals to control operation of the motor for actuation of, e.g., propeller 20. Examples of motor 84 can include electric motors, combustion motors (e.g., gas motors), or other types of motors.

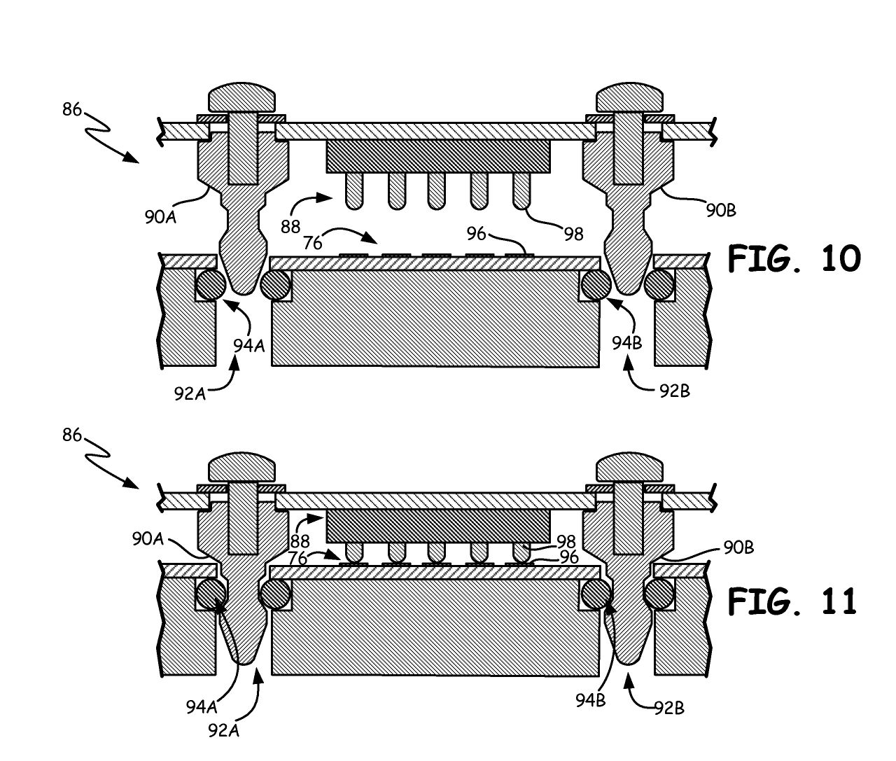

FIG. 10 is a schematic side view of one example of electrical interface 86 including electrical components 76 and 88. As illustrated in FIG. 10, electrical interface 86 can further include alignment posts 90A and 90B (collectively referred to herein as “alignment posts 90”), bores 92A and 92B (collectively referred to herein as “bores 92”), and canted springs 94A and 94B (collectively referred to herein as “canted springs 94”). As further illustrated, electrical component 76 can, in one example, include a plurality of electrical pads 96. Electrical component 88 can include, in one example, a plurality of electrical pins 98. As in the example of FIG. 10, electrical component 88 can be disposed at a lift assembly (e.g., fixed wing lift assembly 12, quad-rotor lift assembly 14, or other lift assemblies). Electrical component 76 can be disposed at mounting portion 18 of fuselage 16. While the example of FIG. 10 illustrates electrical component 88 as including electrical pins 98 and electrical component 76 as including electrical pads 96, in other examples, electrical component 88 can include electrical pads 96 and electrical component 76 can include electrical pins 98, as is further described below.

Electrical pads 96 can be electrically connected to controller 78 (illustrated in FIG. 9). Electrical pads 96 can be disposed to interface with electrical pins 98, such that each of electrical pins 98 aligns with one of electrical pads 96 when electrical component 88 is mated with electrical component 76. One or more of electrical pins 98 can be retractable electrical pins. As such, one or more of electrical pins 98 can be retracted such that the retracted pin does not contact the corresponding one of electrical pads 96 when electrical component 88 is mated with electrical component 76. The arrangement of electrical pins 98 that are configured to contact electrical pads 96 when electrical component 88 is mated with electrical component 76 can be considered an active pin arrangement of electrical interface 86. The active pin arrangement can identify a flight modality of a connected lift assembly. For instance, a first lift assembly (e.g., fixed wing lift assembly 12) can correspond to an active pin arrangement in which each of electrical pins 98 contacts a corresponding one of electrical pads 96, and a second lift assembly (e.g., quad-rotor lift assembly 14) can correspond to an active pin arrangement in which all but one of electrical pins 98 contacts a corresponding one of electrical pads 96. In this way, an active pin arrangement of electrical interface 86 can identify a flight modality of a connected one of a plurality of lift assemblies. Controller 78 can determine, based on determining the active pin arrangement, the flight modality of a connected one of a plurality of lift assemblies.

As illustrated in FIG. 10, each of bores 92 can be configured to receive one of alignment posts 90. Alignment posts 90 and bores 92 can be arranged to align electrical pins 98 and electrical pads 96 when electrical component 88 is mated with electrical component 76, thereby enabling blind mating of electrical components 88 and 76. Canted springs 94 are configured to retain alignment posts 90 when electrical component 88 is mated with electrical component 76. In some examples, electrical interface 86 may not include canted springs 94, but may retain alignment posts 90 within bores 92 using an interference fit or other retaining mechanism. In other examples, bores 92 may be configured to receive alignment posts 90 but not retain alignment posts 90 when electrical component 88 is mated with electrical component 76. In some examples, electrical interface 86 can include greater or fewer than the two alignment posts 90 illustrated in FIG. 10, such as one, three, or more alignment posts 90.

FIG. 11 is a schematic side view of the example of electrical interface 86 of FIG. 10 showing electrical component 88 mated with electrical component 76. In the illustrated example of FIG. 11, each of alignment posts 90 is inserted within a corresponding one of bores 92. Canted springs 94 rest within beveled portions of guide posts 90 to retain guide posts 90 within bores 92. The arrangement of alignment posts 90 and bores 94 aligns electrical pins 98 of electrical component 88 with electrical pads 96 of electrical component 76 such that electrical pins 98 contact electrical pads 96. As illustrated in FIG. 11, canted springs 94 are configured to fit within recessed portions of guide posts 94 to retain alignment posts 90 and maintain electrical pins 98 in a compressed and connected configuration with electrical pads 96 when electrical component 88 is mated with electrical component 76.

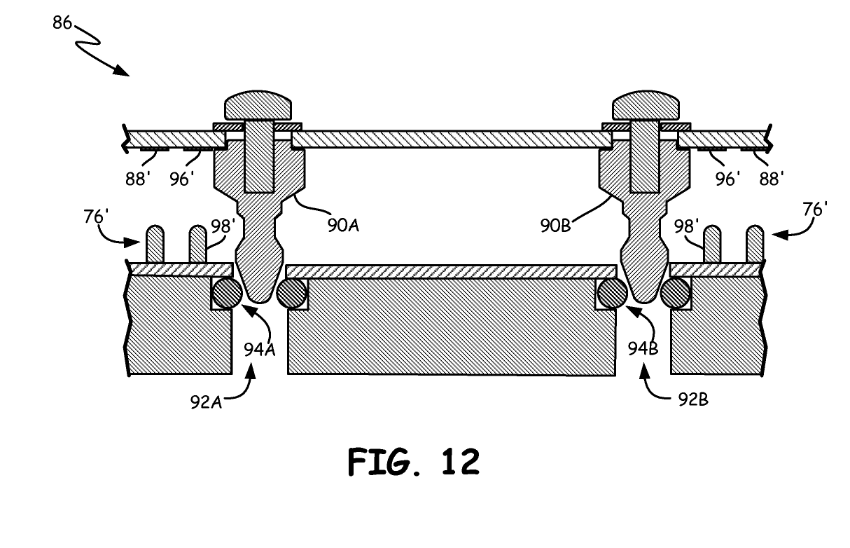

FIG. 12 is a schematic side view of another example of electrical interface 86. As illustrated in FIG. 12, electrical interface 86 can include guide posts 90 configured to be received by bores 92 and retained by canted springs 94. In this example, electrical interface 86 includes electrical component 88′ and electrical component 76′. Electrical component 88′ includes electrical pads 96′ disposed at opposite ends of electrical component 88′. Electrical component 76′ includes electrical pins 98′ arranged to align with electrical pads 96′ when electrical component 88′ is mated with electrical component 76′.

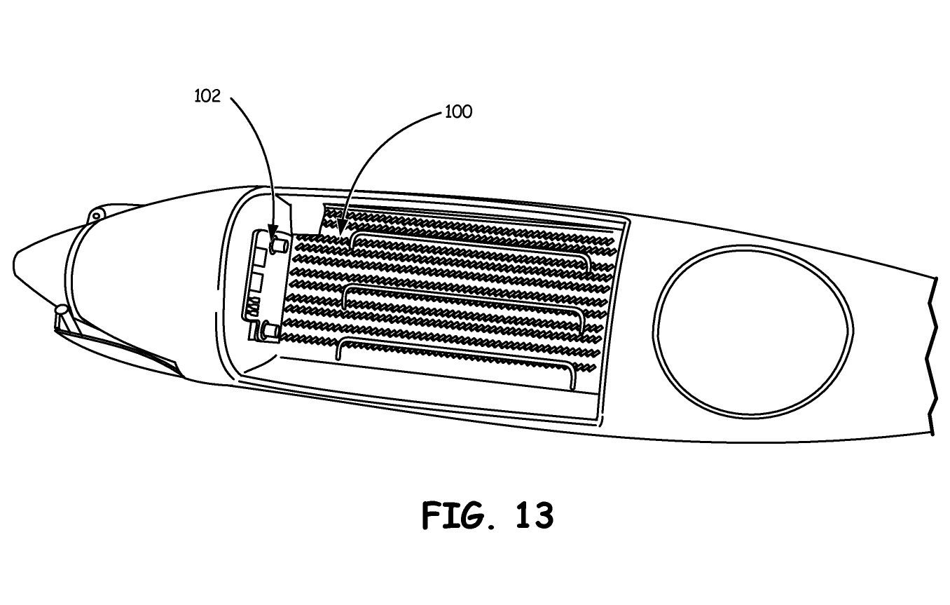

FIG. 13 is a perspective view of a bottom side of fuselage 16 including power source mounting cavity 100 that is configured to receive a power source that supplies power to components of the UAV. As illustrated in FIG. 13, power source mounting cavity 100 can include power source connection 102. Power source mounting cavity 100 can be configured to receive a power source, such as a battery, a fuel cell, a motor, an engine, or other power source. Power source connection 102 can be an electrical connection configured to mate with a corresponding electrical connection of a power source, such as a corresponding electrical connection of a battery. Power source connection 102 can be electrically connected to components of the UAV to supply electrical power from a connected power source to components of the UAV, such as motors, actuators, controllers, or other electrical components of the UAV. In some examples, power source mounting cavity 100 and power source connection 102 can be configured to interchangeably receive any of a plurality of power sources, such as any of a battery, a fuel cell, a generator, or other power source.

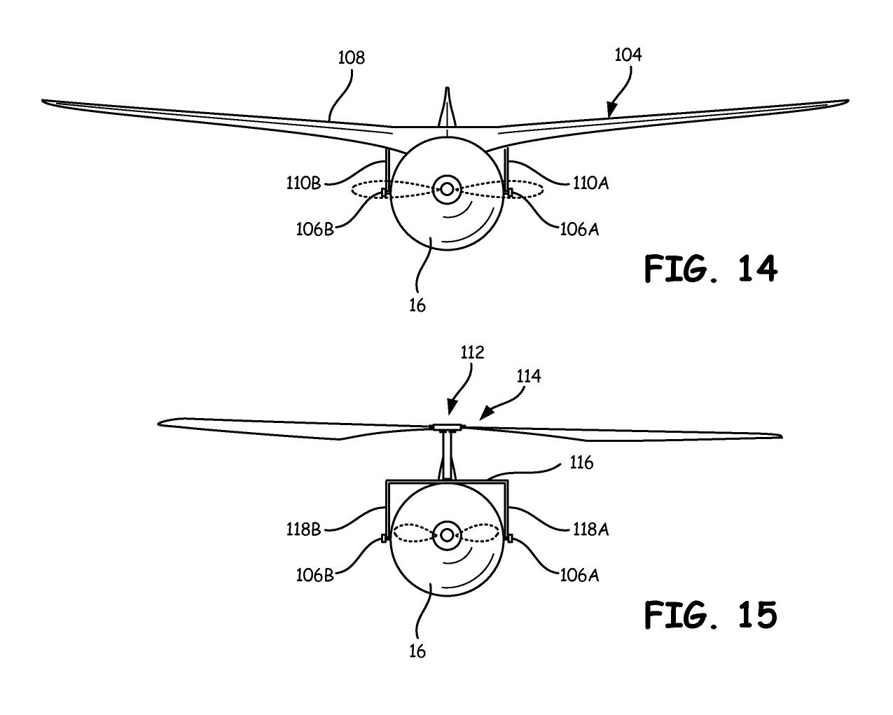

FIG. 14 is a front view of an alternate embodiment of fuselage 16 coupled to fixed wing lift assembly 104 via attachment mechanisms 106A and 106B. FIG. 14 illustrates another embodiment of attachment mechanisms that can be utilized to connect any of a plurality of lift assemblies to fuselage 16. In the example of FIG. 14, fixed wind lift assembly 104 includes wing portion 108 and extension arms 110A and 110B (collectively referred to herein as “extension arms 110”). Extension arms 110, which can be formed of any lightweight material having high tensile strength (e.g., aluminum, titanium, carbon fiber composite, or other materials), extend from an underside of wing portion 108 toward port and starboard sides of fuselage 16, respectively. Extension arms 110 connect to fuselage 16 via attachment mechanisms 106A and 106B (collectively referred to herein as “attachment mechanisms 106”). Examples of attachment mechanisms 106 can include bolted connections, cam connections, interference fit connections, or other attachment mechanisms capable of securing extension arms 110 to fuselage 16.

FIG. 15 is a front view of an alternate embodiment of fuselage 16 coupled to single-rotor lift assembly 112 via attachment mechanisms 106. As illustrated, single-rotor lift assembly 112 can include rotor 114 that connects to mounting plate 116. Extension arms 118A and 118B (collectively referred to herein as “extension arms 118”) extend from mounting plate 116 toward port and starboard sides of fuselage 16, respectively. Extension arms 118 connect to fuselage 16 via attachment mechanisms 106. Accordingly, attachment mechanisms 106 can be considered attachment mechanisms that are configured to mount with any of a plurality of lift assemblies.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An unmanned aerial vehicle comprising:
a fuselage; and
a lift assembly selected from a plurality of lift assemblies, each of the plurality of lift assemblies having a different flight modality;
wherein the fuselage comprises a mounting portion configured to mount with any of the plurality of lift assemblies.

2. The unmanned aerial vehicle of claim 1, wherein the plurality of lift assemblies comprises a fixed wing lift assembly.

3. The unmanned aerial vehicle of claim 1, wherein the plurality of lift assemblies comprises a rotor lift assembly.

4. The unmanned aerial vehicle of claim 1, further comprising an electrical interface, the electrical interface comprising:
a first electrical component disposed at the fuselage, the first electrical component having a first electrical contact portion; and
a second electrical component disposed at the lift assembly, the second electrical component having a second electrical contact portion configured to interface with the first electrical contact portion.

5. The unmanned aerial vehicle of claim 4, wherein the electrical interface is configured to identify the flight modality of the lift assembly.

6. The unmanned aerial vehicle of claim 4,
wherein the first electrical contact portion comprises one or more electrical pads; and
wherein the second electrical contact portion comprises one or more electrical pins.

7. The unmanned aerial vehicle of claim 6, wherein at least one of the one or more electrical pins of the second electrical contact portion comprises a retractable electrical pin.

8. The unmanned aerial vehicle of claim 4, wherein the electrical interface further comprises:
a plurality of alignment posts; and
a plurality of bores, each of the plurality of bores configured to receive one of the plurality of alignment posts;
wherein the plurality of alignment posts and the plurality of bores are disposed to align the first electrical contact portion and the second electrical contact portion when the plurality of alignment posts are inserted into the plurality of bores.

9. The unmanned aerial vehicle of claim 8,
wherein the plurality of alignment posts are disposed at the lift assembly; and
wherein the plurality of bores are disposed at the fuselage.

10. The unmanned aerial vehicle of claim 1, wherein the mounting portion comprises a first attachment mechanism and a second attachment mechanism, each of the first and second attachment mechanisms configured to secure the lift assembly to the fuselage.

11. The unmanned aerial vehicle of claim 10,
wherein the first attachment mechanism comprises a female mating component disposed at the mounting portion of the fuselage; and
wherein the lift assembly comprises a male mating component configured to mate with the female mating component.

12. The unmanned aerial vehicle of claim 11, wherein the female mating component comprises an arcuate recess.

13. The unmanned aerial vehicle of claim 1, further comprising:
a controller disposed at the fuselage, wherein the controller is electrically coupled to the electrical interface.

14. The unmanned aerial vehicle of claim 13, further comprising:
at least one sensor configured to sense data corresponding to flight conditions of the unmanned aerial vehicle;
wherein the controller is communicatively coupled to the at least one sensor.

15. An unmanned aerial vehicle comprising:
a fuselage comprising a mounting portion configured to mount with any of a plurality of lift assemblies, each of the plurality of lift assemblies having a different flight modality and one or more flight control surfaces corresponding to the respective flight modality;
an electrical interface configured to:
electrically connect the fuselage and any of the plurality of lift assemblies; and
identify the flight modality of an electrically connected one of the plurality of lift assemblies; and
a controller coupled to the electrical interface and configured to:
determine the flight modality of the electrically connected one of the plurality of lift assemblies based on the electrical interface; and
provide control signals, based on the determined flight modality, to the flight control surfaces of the electrically connected one of the plurality of lift assemblies.

16. The unmanned aerial vehicle of claim 15, wherein the plurality of lift assemblies comprises:
a fixed wing lift assembly; and
a multi-rotor lift assembly.

17. The unmanned aerial vehicle of claim 15, wherein the controller comprises an autopilot configured to autonomously control flight of the unmanned aerial vehicle.

18. The unmanned aerial vehicle of claim 15, wherein the controller is configured to provide control signals to the flight control surfaces of the electrically connected one of the plurality of lift assemblies by at least being configured to select one or more parameters of a flight control law based on the determined flight modality.

19. The unmanned aerial vehicle of claim 15, wherein the controller is configured to provide control signals to the flight control surfaces of the electrically connected one of the plurality of lift assemblies by at least being configured to select one or more flight control laws based on the determined flight modality.

20. An unmanned aerial vehicle comprising:
an elongate body portion;
a lift assembly connected to the elongate body portion via an attachment mechanism, the lift assembly selected from a plurality of lift assemblies, each having a different flight modality;
wherein the attachment mechanism is configured to connect the elongate body portion to any of the plurality of lift assemblies.

21. An unmanned aerial vehicle system comprising:
a fixed wing lift assembly;
a rotor lift assembly; and
a fuselage having a mounting portion configured to mount with each of the fixed wing lift assembly and the rotor lift assembly via a common attachment mechanism.

22. The unmanned aerial vehicle system of claim 21, further comprising:
a controller disposed at the fuselage; and
an electrical interface configured to connect the controller and each of the fixed wing lift wing assembly and the rotor lift assembly;
wherein the controller is configured to:
identify which of the fixed wing lift assembly and the rotor lift assembly is connected via the electrical interface; and
provide flight control of the unmanned aerial vehicle based on the identified one of the fixed wing lift assembly and the rotor lift assembly.
